(19) United States
(12) Patent Application Publication
(10) Pub. No.: US 2026/0225392 A1
(43) Pub. Date: Aug. 6, 2026

(54) BOOKLET CREATING APPARATUS THAT CREATES BOOKLET

(71) Applicant: CANON KABUSHIKI KAISHA, Tokyo (JP)

(72) Inventor: HIROKI EGUCHI, Kanagawa (JP)

(21) Appl. No.: 19/463,284

(22) Filed: Jan. 29, 2026

(30) Foreign Application Priority Data
Feb. 3, 2025 (JP) 2025-016284

(51) Int. Cl. B42C 9/00; B42C 1/12; G03G 15/00; G03G 15/043; G06K 15/02

(52) U.S. Cl. CPC B42C 9/0081; G03G 15/043; G03G 15/5062; G03G 15/6544; G03G 15/6585; B42C 1/12; G03G 2215/00835; G03G 2215/00936; G06K 15/027; G06K 15/1843

(57) ABSTRACT

A booklet creating apparatus forms an adhesive image on a sheet based on first adhesive image information, outputs second adhesive image information by detecting the adhesive image formed on the sheet, and in accordance with a difference between a predetermined pressing position and a position of the adhesive image in the second adhesive image information, corrects at least one of the first adhesive image information, the predetermined pressing position, an image formation condition, and a booklet creation condition.

### BACKGROUND

### Field of the Technology

The present disclosure relates to a booklet creating apparatus that creates a booklet.

### Description of the Related Art

Japanese Patent Laid-Open No. 2013-043751 discloses a booklet creating apparatus that creates a booklet by adhering a plurality of sheets to each other using toner. The adhesion strength required for adhesive layers of the booklet varies depending on the number of sheets that form the booklet and the type of the sheets. According to Japanese Patent Laid-Open No. 2013-043751, a user specifies the adhesion strength through a console.

According to Japanese Patent Laid-Open No. 2013-043751, the user must specify the adhesion strength, which has been troublesome for the user. There has thus been demand from the market for reducing the involvement required of the user.

### SUMMARY

The present disclosure provides a booklet creating apparatus comprising: an image forming unit configured to form, on a sheet, an adhesive image based on first adhesive image information, the first adhesive image information including data indicative of a target position on the sheet at which the adhesive image is to be formed; a detecting unit configured to detect the adhesive image formed on the sheet and to output second adhesive image information including position information indicative of an actual position of the adhesive image on the sheet; a booklet creating unit configured to create a booklet by pressing and heating the sheet at a predetermined pressing position to melt the adhesive image and form an adhesive layer, and adhering a plurality of sheets together via the adhesive layer; and a processor configured to, in accordance with a difference between (i) the predetermined pressing position and (ii) the actual position of the adhesive image indicated by the position information included in the second adhesive image information, correct at least one of the first adhesive image information, the predetermined pressing position, an image-formation condition of the image forming unit, and a booklet-creation condition of the booklet creating unit.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an image forming system.

FIGS. 2A to 2C are diagrams illustrating the formation positions of adhesive images.

FIGS. 3A to 3D are diagrams illustrating a booklet creation method.

FIGS. 4A to 4C are diagrams illustrating thermocompression bonding processing.

FIGS. 5A and 5B are diagrams illustrating misalignment of an adhesive image relative to a pressing position.

FIGS. 6A and 6B are diagrams illustrating a method for measuring adhesion strength.

FIGS. 7A and 7B are diagrams illustrating verification results.

FIG. 8 is a diagram illustrating a controller.

FIG. 9 is a diagram illustrating a correction unit.

FIG. 10 is a flowchart illustrating correction processing.

FIG. 11 is a flowchart illustrating correction processing.

FIG. 12 is a diagram illustrating a toner consumption amount.

FIG. 13 is a flowchart illustrating correction processing.

FIG. 14 is a diagram illustrating an image forming system.

FIG. 15 is a flowchart illustrating processing for updating a pressing position.

FIG. 16 is a diagram illustrating a method for identifying a pressing position.

FIG. 17 is a diagram illustrating an image forming system.

FIG. 18 is a flowchart illustrating processing for correcting an image formation condition.

FIG. 19 is a diagram illustrating processing for correcting an exposure light amount.

FIG. 20 is a diagram illustrating an image forming system.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment

### 1-1. Image Forming System

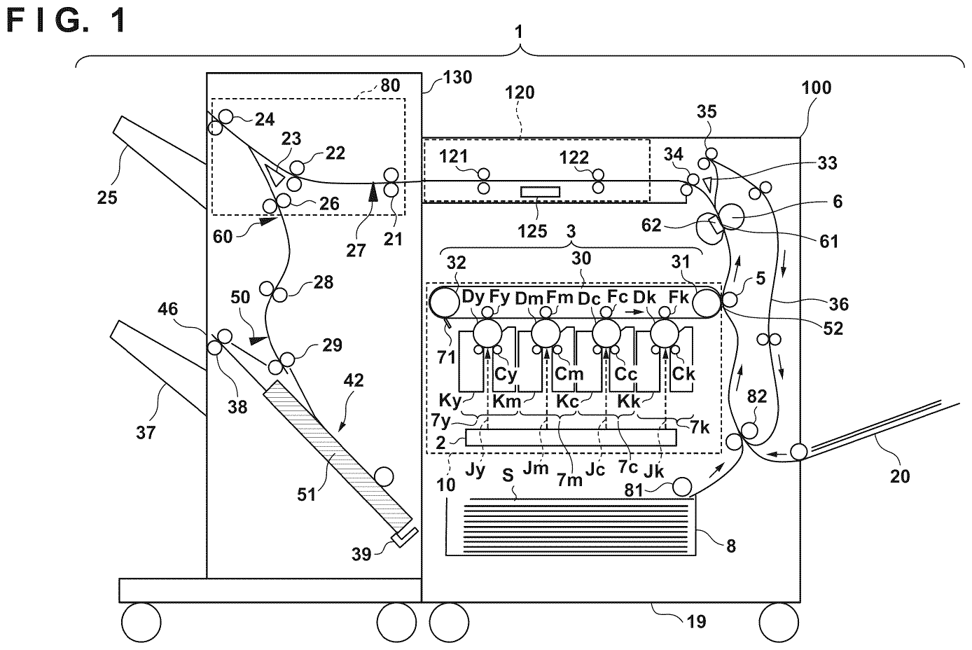

As illustrated in FIG. 1, an image forming system 1 includes an image forming apparatus 100 and a post-processing apparatus 130. The post-processing apparatus 130 is a sheet processing apparatus connected to the image forming apparatus 100. The image forming apparatus 100 forms an image on a sheet S, which is a recording material. An intermediate conveyance unit 120 conveys the sheet S on which the image has been formed to the post-processing apparatus 130. The post-processing apparatus 130 performs post-processing on the sheet S and outputs the processed sheet as necessary. Note that the image forming system 1 may be understood as being a booklet creating apparatus, or the post-processing apparatus 130 may be understood as being a booklet creating apparatus. The image forming system 1 may be called an “image forming apparatus”.

The image forming apparatus 100 includes a fixing apparatus 6, a sheet cassette 8, an image forming unit 10, and a housing 19 that houses these components. The image forming unit 10 forms a toner image on the sheet S fed from the sheet cassette 8. The fixing apparatus 6 executes fixing processing for fixing the toner image onto the sheet S.

The sheet cassette 8 is provided in a lower part of the image forming apparatus 100. The sheet cassette 8 is inserted into the housing 19 so as to be removable therefrom, and can hold a large number of sheets S. In the present embodiment, the maximum size for the sheet S on which an image can be formed is assumed to be A4 size (297 mm in height×210 mm in width). The long edge of the A4-size sheet S is parallel to a conveyance direction of the sheet S. A feed roller 81 feeds the sheet S from the sheet cassette 8 and passes the sheet S to a conveyance roller pair 82. A multi-tray 20 can also feed the sheets S one at a time.

The image forming unit 10 is a tandem-type electrophotographic unit provided with four process cartridges 7y, 7m, 7c, and 7k, an exposure apparatus 2, and a transfer unit 3. “y”, “m”, “c”, and “k” refer to “yellow”, “magenta”, “cyan”, and “black”, respectively. A transparent toner (a powder adhesive) may be used instead of black. The toner used as the powder adhesive may also be called “adhesive toner”. The letters “y”, “m”, “c”, and “k”, indicating the colors of the toner, may be omitted from the reference signs. The adhesive toner may be transparent or black. If the adhesive toner is transparent, black (process black) is realized by mixing yellow, magenta, and cyan as appropriate. The toner type (material) used as the yellow, magenta, and cyan toners and the adhesive toner is, for example, a thermoplastic resin. Thermoplastic resins include, for example, polyester resin, vinyl resin, acrylic resin, styrene acrylic resin, and the like. The process cartridges 7y, 7m, 7c, and 7k enable a plurality of components that handle the image forming process to be replaced collectively. In other words, a plurality of components are integrated to form the process cartridges 7y, 7m, 7c, and 7k. Note that the arrangement of the process cartridges 7y, 7m, 7c, and 7k in a rotation direction of a transfer belt 30 is merely one example. The process cartridges 7y, 7m, 7c, and 7k are examples of consumables that can be replaced.

The process cartridges 7y, 7m, 7c, and 7k include corresponding developing apparatuses Ky, Km, Kc, and Kk, photosensitive drums Dy, Dm, Dc, and Dk, and charging rollers Cy, Cm, Cc, and Ck. The structures of the process cartridges 7y, 7m, 7c, and 7k are substantially the same as each other, except for the types of toner used therein.

The respective developing apparatuses Ky, Km, Kc, and Kk include a container containing a powder (e.g., toner) and an application roller (application sleeve) for applying the powder to the photosensitive drums Dy, Dm, Dc, and Dk. More specifically, the developing apparatuses Ky, Km, and Kc contain yellow, magenta, and cyan toners, respectively, for forming a visible image on the sheet S. The developing apparatus Kk holds black toner (adhesive toner). The adhesive toner may form a user image (original document image), and may be used in the post-processing apparatus 130 for thermocompression bonding of a plurality of the sheets S. Note that an adhesive image (an adhesive layer) is formed by the adhesive toner on the photosensitive drum Dk as a result of the developing.

The image forming unit 10 may include a fifth process cartridge using an adhesive-only toner. Note that the type of printing toner (e.g., black or transparent) and the number of process cartridges 7 can be changed in accordance with the purpose of the image forming apparatus 100.

The charging rollers Cy, Cm, Cc, and Ck are chargers, and uniformly charge the surfaces of corresponding ones of the photosensitive drums Dy, Dm, Dc, and Dk. The exposure apparatus 2 is disposed below the process cartridges 7y, 7m, 7c, and 7k, and above the sheet cassette 8. The exposure apparatus 2 forms an electrostatic latent image by irradiating the photosensitive drums Dy, Dm, Dc, and Dk with corresponding laser beams Jy, Jm, Jc, and Jk. The exposure apparatus 2 may be called an “optical scanning apparatus”.

The developing apparatuses Ky, Km, Kc, and Kk form toner images by causing the toner to adhere to the electrostatic latent images on the photosensitive drums Dy, Dm, Dc, and Dk. The developing apparatuses Ky, Km, Kc, and Kk may be called “developing apparatuses”.

The transfer unit 3 includes the transfer belt 30, which serves as an intermediate transfer member (a secondary image carrier). The transfer belt 30 is an endless belt stretched around an inner roller 31 and a tension roller 32. An outer circumferential surface (image forming surface) of the transfer belt 30 faces the photosensitive drums Dy, Dm, Dc, and Dk. Primary transfer rollers Fy, Fm, Fc, and Fk are disposed on an inner circumferential side of the transfer belt 30 so as to face the photosensitive drums Dy, Dm, Dc, and Dk.

The primary transfer rollers Fy, Fm, Fc, and Fk transfer toner images from the corresponding photosensitive drums Dy, Dm, Dc, and Dk to the transfer belt 30. The primary transfer rollers Fy, Fm, Fc, and Fk may be called “primary transfer devices”. When the transfer belt 30 rotates counterclockwise, the toner images are conveyed to a secondary transfer part.

A secondary transfer roller 5 is disposed opposite the inner roller 31, and a transfer nip 52 is formed between the secondary transfer roller 5 and the transfer belt 30. The transfer nip 52 transfers the toner image from the transfer belt 30 to the sheet S. The transfer nip 52 may be called a “secondary transfer part”. A cleaning blade 71 is a cleaning member for removing toner remaining on the transfer belt 30. Toner removed by the cleaning blade 71 is collected into a collection container (not shown).

The fixing apparatus 6 is disposed above the secondary transfer roller 5 (downstream in the conveyance direction of the sheet S). The fixing apparatus 6 applies heat and pressure to the sheet S as the sheet S traverses a fixing nip 61. The toner images are fixed onto the sheet S as a result. Note that the fixing apparatus 6 includes a fixing heater 62 for heating the toner images and the sheet S. The fixing heater 62 is a halogen heater or a ceramic heater, for example.

As illustrated in FIG. 1, a switching guide 33 is a flap-shaped guide member provided downstream from the fixing apparatus 6 in the conveyance direction of the sheet S. When a single-sided printing mode, in which an image is formed on one surface of the sheet S, is selected, the switching guide 33 guides the sheet S to discharge rollers 34. When a double-sided printing mode, in which an image is formed on both surfaces of the sheet S, is selected, the switching guide 33 guides the sheet S having an image formed on a first surface to a switchback roller pair 35. The switchback roller pair 35 conveys the sheet S in a predetermined direction. When a trailing end of the sheet S can enter a double-sided conveyance path 36, the switchback roller pair 35 starts to reverse. As a result, the sheet S is conveyed to the double-sided conveyance path 36. The double-sided conveyance path 36 conveys the sheet S to the secondary transfer part again. An image is formed on a second surface of the sheet S as a result.

The discharge rollers 34 convey the sheet S to the intermediate conveyance unit 120. The intermediate conveyance unit 120 has conveyance roller pairs 121 and 122. The conveyance roller pairs 121 and 122 convey the sheet S to the post-processing apparatus 130.

A reading unit 125 that optically reads the surface of the sheet S is disposed between the conveyance roller pair 121 and the conveyance roller pair 122. The reading unit 125 includes, for example, a light-emitting element that emits light for illuminating the sheet S, and a contact image sensor (CIS) that converts light reflected by the sheet S into an image signal. The reading unit 125 outputs the image signal as a reading result of reading the surface of the sheet S.

### 1-2. Post-Processing Apparatus

The post-processing apparatus 130 is a floor-standing sheet processing apparatus. The post-processing apparatus 130 has a mechanism for buffering a plurality of sheets, a mechanism for aligning a plurality of sheets, and a mechanism for adhering (thermocompression bonding) a sheet bundle.

In the following, the end of the sheet S on the front side thereof in the conveyance direction will be called a “leading end”. Similarly, the end of the sheet S on the rear side thereof in the conveyance direction will be called a “trailing end”. Of the two ends of the sheet S, the end that enters the post-processing apparatus 130 first will be called a “first end”. Meanwhile, of the two ends of the sheet S, the end that enters the post-processing apparatus 130 later will be called a “second end”. Note that switch-back conveyance performed by the post-processing apparatus 130 may result in the leading end changing from the first end to the second end and the trailing end changing from the second end to the first end.

The sheet S conveyed from the intermediate conveyance unit 120 is passed to inlet rollers 21 of the post-processing apparatus 130. A sheet sensor 27, called an “inlet sensor”, is disposed downstream from the inlet rollers 21. When the sheet sensor 27 senses the trailing end of the sheet S, a conveyance roller pair 22 accelerates the sheet S. When the trailing end of the sheet S for which the discharge destination is set to an upper tray 25 reaches an area between the conveyance roller pair 22 and a conveyance roller pair 24, the conveyance roller pair 22 decelerates. As a result, the conveyance speed of the sheet S is set to a predetermined discharge speed. The conveyance roller pair 24 discharges the sheet S to the upper tray 25.

When the trailing end of the sheet S for which the discharge destination is set to a lower tray 37 passes a backflow prevention member 23, the conveyance roller pair 24 stops conveying the sheet S. The conveyance roller pair 24 then begins rotating in reverse. As a result, the sheet S is switched back and conveyed to a conveyance roller pair 26. When a sheet sensor 60 provided downstream from the conveyance roller pair 26 senses the leading end of the sheet S, the two rollers constituting the conveyance roller pair 24 separate from each other. This enables the conveyance roller pair 24 to accept a subsequent sheet S. Furthermore, the conveyance roller pair 26 stops in a state where the preceding sheet S is pinched between the conveyance roller pair 26. When the subsequent sheet S arrives, the conveyance roller pair 26 starts rotating in reverse. The subsequent sheet S is overlaid onto the preceding sheet S as a result. When the conveyance roller pair 26 repeats the switchback of the sheets S, a plurality of the sheets S are stacked and a sheet bundle is formed. Such an operation for forming a sheet bundle may be called a “buffering operation”. A unit that implements the buffering operation is called a “buffer unit 80”. Note that it is not necessary to form the sheet bundle using the buffer unit 80. For example, the buffer unit 80 may switch back the sheet S that has arrived from the image forming apparatus 100, and then convey the sheet S to an intermediate stacking unit 42. In this case, a sheet bundle is formed in the intermediate stacking unit 42.

When the sheet bundle is completed in the buffer unit 80, the conveyance roller pair 26 conveys the sheet bundle toward the intermediate stacking unit 42. The sheet bundle traverses a conveyance roller pair 28 and a sheet sensor 50. Furthermore, the sheet bundle is conveyed to the intermediate stacking unit 42 by a kick-out roller pair 29. A longitudinal aligning plate 39, which is movable, is disposed in a standby position, at a part of the intermediate stacking unit 42 that is furthest downstream. When the sheet bundle presses against the longitudinal aligning plate 39, the sheet bundle is aligned.

A plurality of sheet bundles are stacked in order on the intermediate stacking unit 42. Note that the sheet bundle that is conveyed to the intermediate stacking unit 42 first will be called a “first sheet bundle”. The i-th sheet bundle to arrive at the intermediate stacking unit 42 will be called an “i-th sheet bundle”. The sheet bundle that arrives at the intermediate stacking unit 42 last will be called an “N-th sheet bundle”. As a result, a predetermined number of sheets S that are to form a booklet are stacked on the intermediate stacking unit 42. Once a predetermined number of sheets S have been aligned, a booklet is formed by a thermocompression bonding unit 51 performing a binding operation (thermocompression bonding processing). The thermocompression bonding processing may be repeated each time a sheet bundle arrives at the intermediate stacking unit 42. The longitudinal aligning plate 39 moves from the standby position to a discharge position, and as a result, the booklet is pushed toward a discharge roller pair 38. Once the leading end of the booklet is pinched by the discharge roller pair 38, the longitudinal aligning plate 39 stops and then returns to the standby position. The booklet received from the longitudinal aligning plate 39 is discharged to the lower tray 37 from a discharge port 46 by the discharge roller pair 38.

The foregoing described the post-processing apparatus 130 as forming a sheet bundle constituted by a plurality of sheets S by using the buffer unit 80, and conveying the sheet bundle to the intermediate stacking unit 42. However, a single sheet S may be conveyed to the intermediate stacking unit 42.

### 1-3. Printing Region of Adhesive Image Aim

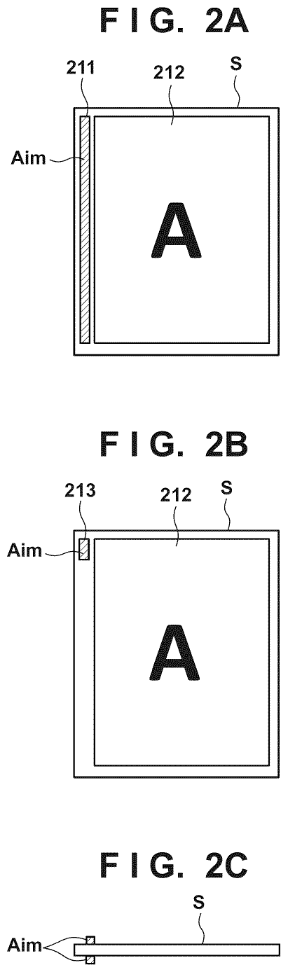

FIG. 2A illustrates a printing region 211 of an adhesive image Aim. The printing region 211 is an adhesive region secured in the binding margin of the sheet S. In this example, the printing region 211 extends parallel to the long edge of the sheet S. The printing region 211 is provided at the left end or the right end near the long edge. The printing region 211 of a right-bound booklet is disposed at the right end of the sheet S. The printing region 211 of a left-bound booklet is disposed at the left end of the sheet S. The printing region 211 may be provided at the upper end or the lower end near the short side. By overlaying a plurality of sheets S and performing heat treatment and pressure treatment on the printing regions 211 of the plurality of sheets S, the post-processing apparatus 130 adheres the plurality of sheets S to each other to form a booklet. In this case, the booklet is bound on the long edge. Here, the width (the length in the short side direction) of the adhesive toner image (the printing region 211) is 4.0 mm, for example. For example, the amount of toner per unit area of the adhesive image Aim (i.e., an application amount) may be 0.4 mg/cm². A printing region 212 is a region in which a user image is printed.

As illustrated in FIG. 2B, a small printing region 213 for the adhesive image Aim may be formed near a corner of the sheet S. A booklet bound at the corner is created as a result. The image of the adhesive image Aim is not formed on the sheet S that serves as the cover of the booklet. The printing region 213 of a right-bound booklet is disposed in the upper-right of the sheet S. The printing region 213 of a left-bound booklet is disposed in the upper-left of the sheet S.

As illustrated in FIG. 2C, the printing regions 211 and 213 of the adhesive image Aim may be formed on both surfaces of the sheet S, or may be formed on only one surface of the sheet S. Whether the printing regions 211 and 213 of the adhesive image Aim are formed on only one surface or on both surfaces can be selected in consideration of, for example, the adhesive performance of the post-processing apparatus 130, the adhesive performance of the adhesive image Aim, the type of the sheet S, the purpose of the booklet, and the like. Reliable adhesion is necessary for booklets that will be handled as archival editions. Reliable adhesion is also necessary when heavy paper or a special sheet S is used for the cover of the booklet. Accordingly, in these cases, the printing region 211 of the adhesive image Aim is provided on both surfaces of the sheet S. However, when creating a simple booklet for temporary use, the printing region 211 of the adhesive image Aim may be formed on only one surface of the sheet S.

When the adhesive image Aim is formed on both surfaces of the sheet S, the adhesive image Aim formed on the front surface of one sheet S and the adhesive image Aim formed on the back surface of another sheet S are placed in contact with and adhered to each other. Note that the adhesive image Aim is formed on the back surface of the front cover of the booklet and the front surface of the back cover, but the adhesive image Aim is not formed on the front surface of the front cover or the back surface of the back cover.

### 1-4. Booklet Creation Operations

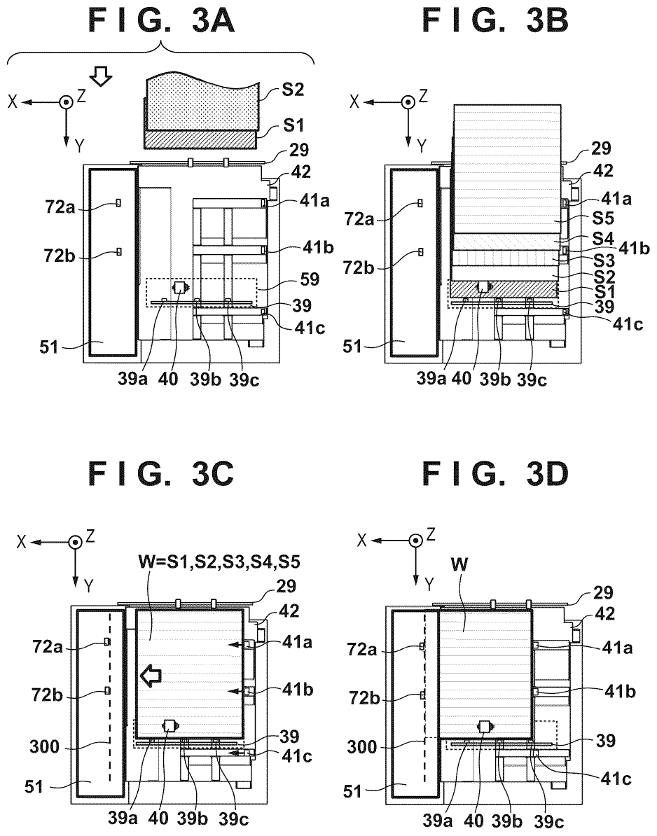

FIGS. 3A to 3D illustrate booklet creation operations performed by the intermediate stacking unit 42. The initial state is a state in which the intermediate stacking unit 42 is empty. As an example, a sheet bundle W constituted by five sheets S1 to S5 is conveyed from the buffer unit 80 to the intermediate stacking unit 42. The intermediate stacking unit 42 functions as a support member or a holding member that supports the five sheets S1 to S5.

A Y direction is a direction parallel to a stacking surface (stacking plate) of the intermediate stacking unit 42 on which the sheets S are stacked, and parallel to the conveyance direction of the sheets S conveyed from the kick-out roller pair 29 to the intermediate stacking unit 42. The Y direction may be called a “longitudinal direction”. An X direction is a direction parallel to the stacking surface of the intermediate stacking unit 42 on which the sheets S are stacked, and orthogonal to the Y direction. The X direction may also be called a “lateral direction”. AZ direction is a direction orthogonal to the X direction and the Y direction (the normal direction of the stacking surface; the thickness direction of the stacked sheets S). The Z direction may also be called a “height direction”. The opposite directions for the X direction, the Y direction, and the Z direction may be called the “−X direction”, the “−Y direction”, and the “−Z direction”, respectively.

The longitudinal aligning plate 39 and an alignment roller 40 function as a first alignment unit that aligns a plurality of the sheets S in a first direction (the Y direction). The longitudinal aligning plate 39 is disposed at the part of the intermediate stacking unit 42 furthest downstream in the Y direction. The longitudinal aligning plate 39 is a reference member (first reference member) that serves as a reference for a sheet position in the Y direction. The alignment roller 40 is a conveyance member that conveys the sheets S in the Y direction in order to align the sheets S by pressing the sheets S against the longitudinal aligning plate 39. The longitudinal aligning plate 39 includes a plurality of contact parts 39a to 39c disposed at intervals in the X direction. The contact parts 39a to 39c may also be called “longitudinal reference plates”. The plurality of contact parts 39a to 39c make contact with the ends of the sheets S. The longitudinal aligning plate 39 and the alignment roller 40 are integrally configured as a movable unit 59 capable of moving in the Y direction. The movable unit 59 can move in the Y direction using a drive source such as a motor. In other words, the positions of the longitudinal aligning plate 39 and the alignment roller 40 in the Y direction can be adjusted. Lateral aligning plates 41a to 41c of a lateral alignment jogger 41 function as an alignment unit that aligns the sheets S in the X direction orthogonal to the Y direction.

The lateral aligning plates 41a to 41c move in the X direction using a drive source such as a motor, and press the side ends of the sheets S stacked on the intermediate stacking unit 42. Lateral reference plates 72a and 72b are reference members that serve as a reference for the position of the sheets S in the X direction. The lateral reference plates 72a and 72b are disposed opposite the lateral aligning plates 41a and 41b in the X direction.

### 1-4-1. Preparation Stage

As illustrated in FIG. 3A, the sheets S1 to S5 are conveyed toward the kick-out roller pair 29. The sheets S1 to S5 may be conveyed to the intermediate stacking unit 42 in a state in which a sheet Sj positioned lower protrudes further in the Y direction than a sheet Sj+1 positioned higher. Here, j is an index of the sheets S. Before the sheets S are stacked on the intermediate stacking unit 42, the longitudinal aligning plate 39 moves to a predetermined standby position in advance in accordance with the size of the sheets S to be aligned. The standby position is set such that the end position of the sheet S in the −Y direction is at a predetermined position regardless of the size of the sheets S. In other words, the standby position is a position at which the distance, in the Y direction, from the nip position of the kick-out roller pair 29 to the longitudinal aligning plate 39 is slightly longer than the length of the sheets in the Y direction. The lateral aligning plates 41a to 41c stand by in a position on the outer side, in the X direction, of the sheets S being conveyed, so as not to interfere with the conveyance of the sheets S.

### 1-4-2. Longitudinal Alignment Stage

FIG. 3B illustrates the trailing end of the first sheet S1 having exited the nip of the kick-out roller pair 29, and the leading end of the sheet S1 having reached the alignment roller 40. The sheet S1 is pressed against the longitudinal aligning plate 39, and is aligned according to the position of the longitudinal aligning plate 39. When the alignment roller 40 continues to rotate, the sheets S2 to S5 that reach the alignment roller 40 after the sheet S1 are pressed against the longitudinal aligning plate 39 in that order. As a result, the five sheets S1 to S5 are aligned in the Y direction (the longitudinal direction) according to the position of the longitudinal aligning plate 39.

### 1-4-3. Lateral Alignment Stage

FIG. 3C illustrates the alignment of the sheets S1 to S5 in the X direction (the lateral direction) having started after the alignment in the Y direction (the longitudinal direction) is complete. The lateral aligning plates 41a to 41c are driven in the X direction, which is the alignment direction, make contact with the side ends of the sheets S1 to S5, and press the sheets S1 to S5 toward the lateral reference plates 72a and 72b. The other side ends of the sheets S1 to S5 then make contact with contact surfaces 300 of the lateral reference plates 72a and 72b, and the sheets S1 to S5 are aligned in the X direction (the lateral direction) with the positions of the lateral reference plates 72a and 72b as a reference.

### 1-4-4. Adhesion Stage (Thermocompression Bonding Stage)

FIG. 3D illustrates a state in which the alignment of the five sheets S1 to S5 in the X direction and the Y direction is complete. A target position in the alignment operations (an alignment position) is the position of the sheet bundle W when adhesion processing (thermocompression bonding) is performed by the thermocompression bonding unit 51. As described above, the image forming apparatus 100 forms the adhesive image Aim on the sheets S1 to S5 such that the side on which the adhesive toner image is formed corresponds to the side on which the thermocompression bonding unit 51 is located. The adhesive image Aim may not be formed if the sheet S1 is the cover of the booklet.

The thermocompression bonding unit 51 performs thermocompression bonding on the aligned sheets S1 to S5. During this time, the lateral aligning plates 41a to 41c retract in the −X direction. As a result, the intermediate stacking unit 42 enters a state in which the next plurality of sheets S can be accepted. The sheet bundle W constituted by sheets S6 to S10, formed by the buffer unit 80, is then stacked on the sheets S1 to S5.

The four stages described above are then repeated for the preceding sheet bundle W constituted by the bonded sheets S1 to S5 and the sheet bundle W constituted by the unbonded sheets S6 to S10. As a result, the sheets S1 to S10 are adhered in a state in which the sheets S1 to S10 are aligned with a high level of accuracy.

For example, the sheet bundle W is constituted by five sheets S. However, the number of sheets S constituting the sheet bundle W may be two, three, or the like. In other words, the number of sheets S included in the sheet bundle W may be any number less than or equal to the maximum number of sheets S that can be stacked in the buffer unit 80.

### 1-5. Thermocompression Bonding Unit

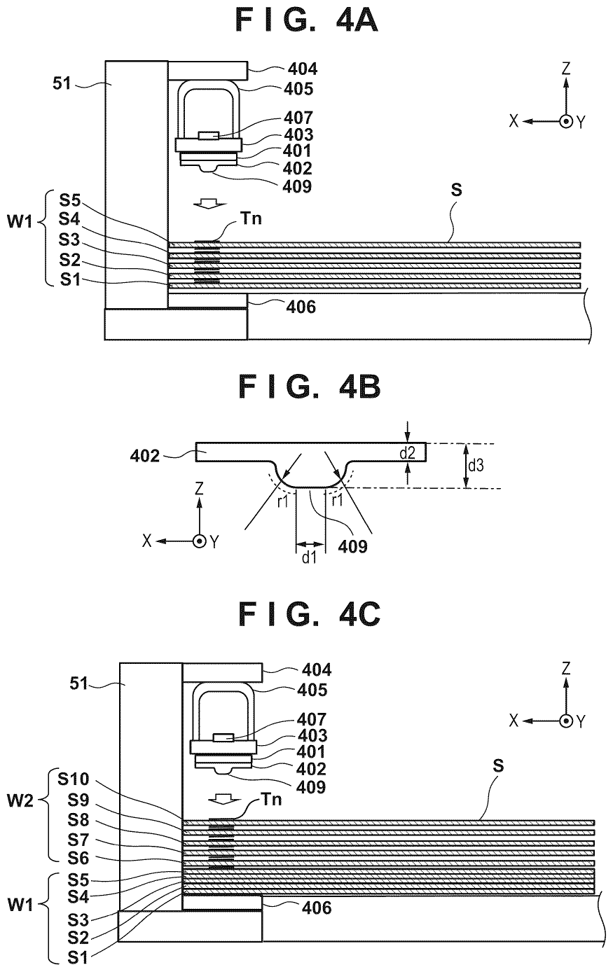

As illustrated in FIG. 4A, the thermocompression bonding unit 51 includes a heater 401 having a heating element as a heat source, and an aluminum heating plate 402 disposed thereon. The surface of the heating plate 402 may be coated. This is to improve the releasability with respect to the toner. The coating material is, for example, a copolymer of tetrafluoroethylene and perfluoroalkoxyethylene (PFA). The heater 401 is 1.0 mm long (thick) in the Z direction, for example. The heater 401 is 8.0 mm long (wide) in the X direction, for example. The heater 401 is 350 mm long in the Y direction, for example. The heating plate 402 is 1.5 mm thick, for example. The heater 401 is a ceramic heater, for example. The temperature of the heater 401 may be measured by a temperature sensor 407 and controlled by a control circuit such that the measured temperature becomes a target temperature. For example, a target temperature (e.g., 240° C.) is set such that the surface temperature of a pressing part 409 of the heating plate 402 is 200° C. Providing the heating plate 402 with the pressing part 409 concentrates the heat and pressure of the thermocompression bonding unit 51 at a binding position of the sheet bundle W. This improves the heating and pressing efficiency. The elastic modulus of the pressing part 409 is at least 1,000 Pa or more, but may be 10,000 Pa or more. This makes it difficult for the pressing part 409 to deform even if thermocompression bonding is repeated.

FIG. 4B illustrates the dimensions of the heating plate 402. d1 indicates the length (width) of the pressing part 409 in the X direction. d1 is 1.0 mm, for example. d2 indicates the thickness of the heating plate 402, and is 0.8 mm, for example. d3 indicates the thickness of the heating plate 402 from a bottom surface to the pressing part 409, and is 1.5 mm, for example. A curved surface having a curvature of r1 is formed on both sides of the pressing part 409. The curvature r1 is R1.5 mm, for example. The length of the pressing part 409 in the Y direction is, for example, 300 mm.

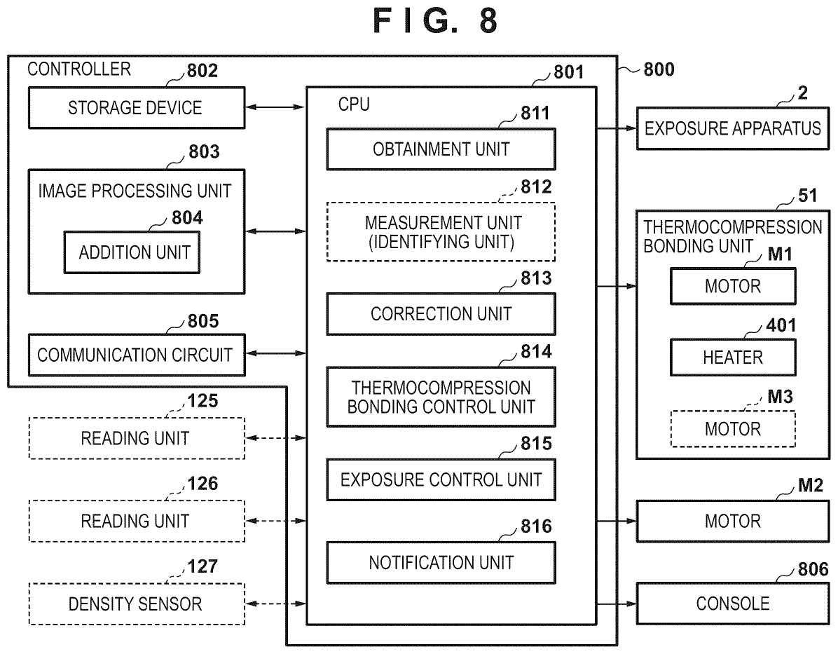

The heater 401 is supported by a heater support member 403 made of a resin. A pressing lever 404 is powered by a motor M1, illustrated in FIG. 8, to push the thermocompression bonding unit 51 in the −Z direction (the downward direction) and press the sheet bundle W. The pressure of the pressing lever 404 is transmitted to the pressing part 409 through a metal stay 405, which is a rigid body. The pressure of the pressing lever 404 can be controlled according to the amount by which the pressing lever 404 is moved in the −Z direction (the downward direction). For example, the average contact pressure acting on the sheet bundle W is 0.2 MPa. A thermocompression bonding time T1 is 2.0 seconds, for example. The thermocompression bonding time may also be called a “contact time”, a “pressing time”, or a “heating time”.

A pressing plate 406 is a receiving member formed from an elastic material (e.g., silicone rubber). An elastic material is used because the pressing plate 406 is a member for receiving pressure in a stable manner. The elastic modulus of the pressing plate 406 is no more than 1,000 Pa, for example. The pressing plate 406 may also be provided with a PFA coating. The pressing plate 406 is 2.0 mm thick, for example. The thermocompression bonding unit 51 presses a sheet bundle W1 constituted by the sheets S1 to S5, and then separates from the sheet bundle W1. The sheets S1 to S5 in FIG. 4A are illustrated as first to fifth sheets S1 to S5 of a booklet serving as a finished product. The sheet S1 is the cover of the booklet. Accordingly, the adhesive image Aim is not formed on the bottom surface of the sheet S1, and the adhesive image Aim is formed only on the top surface. The adhesive image Aim is formed on the top surface and bottom surface of the second and subsequent sheets S2 to S5 of the booklet.

As illustrated in FIG. 4C, a sheet bundle W2 is stacked on the sheets S1 to S5 for which the thermocompression bonding is complete. The sheet bundle W2 is constituted by the sheets S6 to S10. The thermocompression bonding unit 51 performs the thermocompression bonding operation on the sheet bundle W2 stacked on the sheet bundle W1. A booklet constituted by a large number of sheets S is created as a result. Note that the number of sheets constituting the sheet bundle W1 may be different from the number of sheets constituting the sheet bundle W2.

The sheets S6 to S10 that are stacked later are included in the same booklet as the sheets S1 to S5. As such, the adhesive image Aim is formed on the top surface and bottom surface of each of the sheets S6 to S10.

As one example, the post-processing apparatus 130 can create a booklet constituted by a maximum of 100 sheets S. When the creation of the booklet is started, the buffer unit 80 buffers a maximum of five sheets S at a time to create sheet bundles W, and supplies the sheet bundles W to the intermediate stacking unit 42. The thermocompression bonding unit 51 performs the thermocompression bonding operations, which include a descending operation, a pressing operation, and an ascending operation, each time a sheet bundle W arrives. By repeating the buffering operation and the thermocompression bonding operations, a booklet is created efficiently without impairing the productivity of the image forming apparatus 100.

When the thermocompression bonding operations are completed for the sheet bundle W including the last page of the booklet in the intermediate stacking unit 42, the longitudinal aligning plate 39 moves from the standby position to the discharge position. In other words, the completed booklet is pushed out by the longitudinal aligning plate 39 moving parallel toward the discharge port 46. The discharge port 46 is provided with the discharge roller pair 38. Once the leading end of the booklet passes the discharge roller pair 38 slightly, the longitudinal aligning plate 39 stops and then returns to the standby position. The discharge roller pair 38 discharges the booklet to the lower tray 37.

### 1-6. Method for Measuring Amount of Positional Misalignment

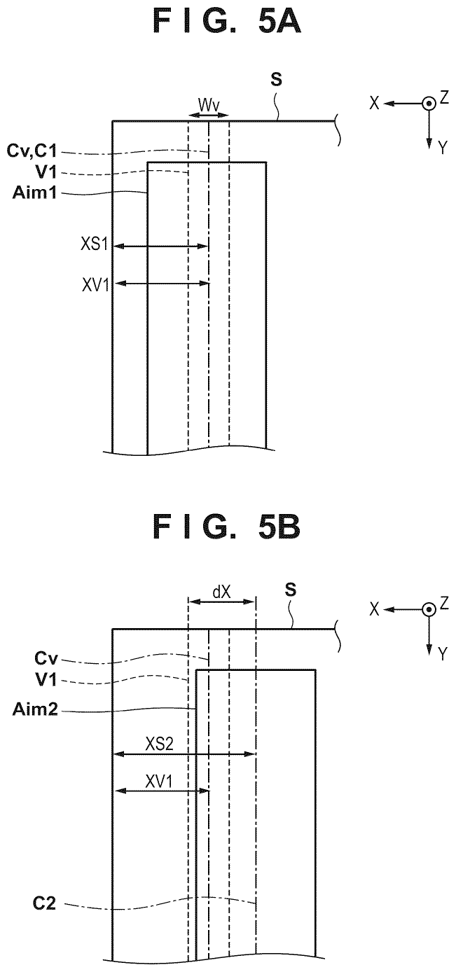

FIG. 5A is an enlarged view of the upper-left part of FIG. 2A. Here, the adhesive image Aim is indicated on the image data. The image data serving as the basis of the adhesive image Aim may be called “first adhesive image information”. For descriptive purposes, the adhesive image Aim in the image data is denoted as “adhesive image Aim1”. The pressing region (pressing position) of the thermocompression bonding unit 51 set in advance is a reference pressing region, and is denoted as a “pressing region V1”. A width Wv of the pressing region V1 in the X direction is 1.5 mm. A width W of the adhesive image Aim1 in the X direction is 4.0 mm. The width W of the adhesive image Aim1 is greater than the width Wv of the pressing region V1. In the X direction, the distance from the end (the long edge) of the sheet S to a center line C1 of the adhesive image Aim1 is denoted as “XS1”. The distance from the end of the sheet S to a center line of the pressing region V1 (called a “reference center line Cv” hereinafter) is denoted as “XV1”. In the image data, XS1 and XV1 are set to equal values (5.0 mm). In other words, the adhesive image Aim1 is disposed so that the pressing region V1 is located in the center of the adhesive image Aim1 in the X direction.

FIG. 5B illustrates the adhesive image Aim formed on the sheet S using the image data of the adhesive image Aim1. The adhesive image Aim formed on the sheet S is read by the reading unit 125 and output as image data. Here, the adhesive image Aim in the image data is a read adhesive image, and will be denoted as “adhesive image Aim2”. Note that the image data or image signal output from the reading unit 125 and including the adhesive image Aim2 may be called “second adhesive image information”.

The position of the adhesive image Aim2 varies depending on the basis weight, the thickness, the presence or absence of surface coating on the sheet S, the position of the sheet S in the sheet cassette 8, and the like. In other words, the position of the adhesive image Aim2 may deviate from the position of the adhesive image Aim1. The distance from the end of the sheet S in the X direction to a center line C2 of the adhesive image Aim2 is denoted as “XS2”. As illustrated in FIGS. 5A and 5B, when the position of the adhesive image Aim2 deviates from the position of the adhesive image Aim1, XS2 and XV1 do not match. A misalignment amount dX, which is a difference between the position of the adhesive image Aim2 and the position of the adhesive image Aim1, is defined by the following equation.

$$dX = \vert XS 2 - XV 1 \vert \qquad Eq 1$$

As illustrated in FIG. 5A, XV1 and XS1 are equal. Eq 1 may therefore be rewritten as follows.

$$dX = \vert XS 2 - XS 1 \vert \qquad Eq 2$$

The misalignment amount dX may vary depending on the position in the Y direction. Accordingly, a misalignment amount dXi may be obtained for each of N positions in the Y direction. Here, i is a natural number from 1 to N. In this case, the misalignment amount dX may be the average of N instances of dXi. If N=5, misalignment amounts dX1 to dX5 can be obtained at 30 mm, 94 mm, 157.5 mm, 212 mm, and 267 mm from the top end of the sheet S in the Y direction.

### 1-7. Method for Measuring Adhesion Strength

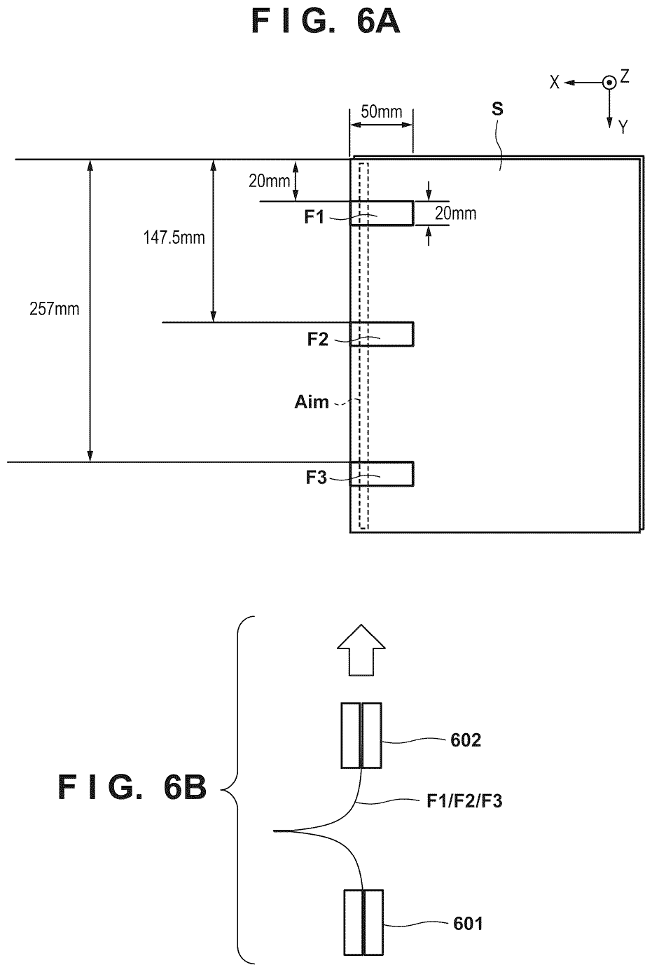

FIGS. 6A and 6B illustrate a method for measuring the adhesion strength (adhesion force). A booklet is formed from two sheets S on which the adhesive image Aim illustrated in FIG. 2A is formed. The surface on which the adhesive image Aim is formed on one of the sheets S and the surface on which the adhesive image Aim is formed on the other of the sheets S are adhered to each other. As a result, a booklet having a total of 0.8 mg/cm² for the adhesive layer is created. This kind of adhesion method is called “double-face adhesion”. A4-sized (297 mm×210 mm) Navigator office paper solutions (Navigator company) paper was used for the sheet S. The grammage of this sheet S is 80 g/m². As illustrated in FIG. 6A, three rectangular test specimens F1, F2, and F3 were cut out on the end side of the booklet where the adhesive layer is formed. The test specimens F1, F2, and F3 were cut out at positions 20 mm, 147.5 mm, and 257 mm from the top end of the booklet, respectively. The length (width) of the test specimens F1, F2, and F3 in the Y direction was 20 mm each. The length of the test specimens F1, F2, and F3 in the X direction was 50 mm each.

As illustrated in FIG. 6B, the cut-out test specimens F1, F2, and F3 were held by holding members 601 and 602 of a testing machine. Here, the testing machine was the TENSILON RTG-1225 (A&D Company). The holding member 601 was fixed. The holding member 602 was moved to pull the test specimens F1, F2, and F3 up at a speed of 50 mm/min. The testing machine measured a peak strength (N) for each of the test specimens F1, F2, and F3. The adhesion strength is the average of the three peak strengths obtained. Here, the average value has been further converted to a load per unit length (N/cm).

### 1-8. Relationship Between Misalignment Amount and Adhesion Strength

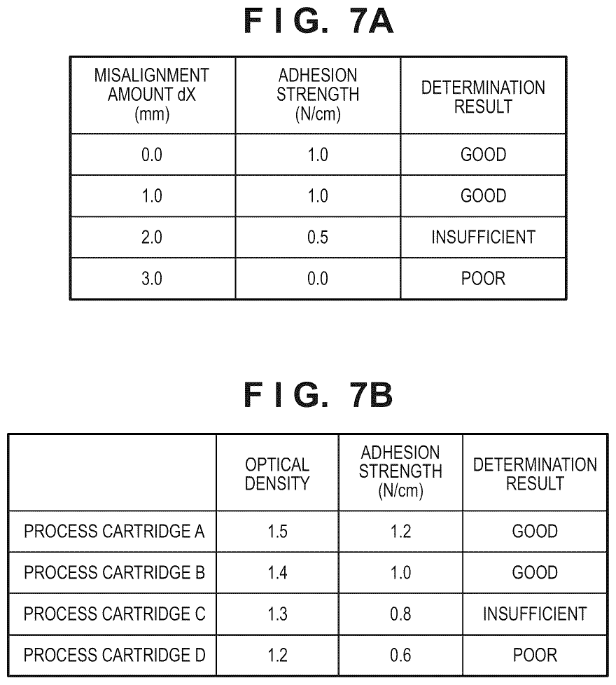

FIG. 7A illustrates results of experiments regarding the relationship between the misalignment amount dX and the adhesion strength. The adhesion strength when the misalignment amount dX was 0.0 mm and 1.0 mm was 1.0 N/cm. The adhesion strength required for a general-purpose booklet is at least 1.0 N/cm. Accordingly, the adhesion strength when the misalignment amount dX is 0.0 mm and 1.0 mm was determined to be good.

As an example, conditions that the width W of the adhesive image Aim is 4.0 mm and the pressed width Wv is 1.5 mm may be assumed. Under these conditions, theoretically, if dX is no greater than 1.25 mm, the pressing part 409 will not protrude from the adhesive image Aim.

The adhesion strength when the misalignment amount dX was 2.0 mm was 0.5 N/cm. If the adhesion strength is 0.5 N/cm, the appearance of a booklet can be maintained, but if a user pulls on the booklet strongly, that sheet S will peel off from the booklet. This means that the strength was determined to be insufficient.

The adhesion strength when the misalignment amount dX was 3.0 mm was 0 N/cm. If the adhesion strength is lower than 0.5 N/cm, the appearance of the booklet is difficult to maintain. As a result, the strength was determined to be poor. Theoretically, if dX exceeds 2.75 mm, the entire region pressed by the pressing part 409 of the thermocompression bonding unit 51 will protrude from the adhesive image Aim2. The adhesion strength will therefore not be expressed.

When the misalignment amount dX increases in this manner, the adhesion strength of the booklet becomes insufficient. A method for increasing the adhesion strength according to the misalignment amount dX is therefore needed.

### 1-9. Controller

FIG. 8 illustrates a controller 800 of the image forming system 1. The plurality of functions with which the controller 800 is provided may be distributed among a plurality of controllers (e.g., a printer controller and an engine controller). In FIG. 8, the broken lines indicate optional functions.

A CPU 801 implements various functions by executing control programs stored in a storage device 802. Some or all of these functions may be implemented by hardware circuitry such as application-specific integrated circuits (ASICs) or field-programmable gate arrays (FPGAs). The storage device 802 can include a read-only memory (ROM), a random access memory (RAM), a hard disk drive (HDD), a solid-state drive (SSD), and the like.

The thermocompression bonding unit 51 includes the motor M1 that drives the pressing lever 404, and the heater 401. A motor M2 rotationally drives a rotating body such as the feed roller 81, for example. A motor M3 is optional, and moves the lateral reference plates 72a and 72b in the +X direction or the −X direction. This is useful for mechanically adjusting the pressing position of the pressing part 409.

A console 806 includes input devices such as a touch sensor and switches, and a display device such as a liquid crystal display. A communication circuit 805 communicates with external devices, such as a print server or a host computer.

The CPU 801 implements a plurality of functions in accordance with control programs stored in the storage device 802. An obtainment unit 811 reads the adhesive image Aim formed on the sheet S using reading units 125 and 126, and saves image data that is the reading result in the RAM region of the storage device 802. In other words, the image data includes the adhesive image Aim2. The reading unit 126 is an image reader having the same form as the reading unit 125, but is installed at a position different from the position of the reading unit 125. The reading unit 126 will be described in detail in other embodiments. A density sensor 127 detects an optical density of the adhesive image Aim formed on the sheet S. In other words, the obtainment unit 811 can obtain the optical density of the adhesive image Aim using the density sensor 127.

A measurement unit 812 forms a test image on a sheet S by causing an image processing unit 803 to supply image data for forming the test image to the exposure apparatus 2. The test image may include a solid image having a predetermined density. Furthermore, the measurement unit 812 obtains a reading result from reading the test image by causing the reading unit 126 to read the test image which has been subjected to the thermocompression bonding processing, and identifies a pressing region (pressing position) of the pressing part 409 from the reading result. The measurement unit 812 is also optional, and will be described in other embodiments.

A correction unit 813 obtains the misalignment amount dX based on the pressing position of the pressing part 409 stored in the storage device 802 and the adhesive image Aim2 obtained by the obtainment unit 811, and corrects at least one parameter that affects the adhesion strength of the adhesive image Aim based on the misalignment amount dX. The correction unit 813 corrects the position at which the adhesive image Aim is formed based on the misalignment amount dX. The correction unit 813 may correct the size of the adhesive image Aim based on the misalignment amount dX. The exposure light amount of the adhesive image Aim may be corrected based on the misalignment amount dX. The correction unit 813 may correct the image data of the adhesive image Aim, or may correct an exposure start position (a writing position) of the adhesive image Aim in the X direction. In either case, the position of the adhesive image Aim on the sheet S is corrected.

A thermocompression bonding control unit 814 controls the thermocompression bonding unit 51. The thermocompression bonding control unit 814 controls the heating temperature of the heater 401, the pressure of the pressing part 409, or the time for which the pressing part 409 is in contact with the sheet S (the thermocompression bonding time). The thermocompression bonding control unit 814 may move the pressing position of the pressing part 409 relative to the sheet S using the motor M3 based on instructions from the correction unit 813.

An exposure control unit 815 controls the exposure timing and the exposure light amount of the exposure apparatus 2. The exposure control unit 815 controls the timing at which the image processing unit 803 outputs the image data to the exposure apparatus 2 based on a synchronization signal output from the exposure apparatus 2. The writing position of the adhesive image Aim may be adjusted by adjusting the time between the synchronization signal and the timing at which the output of the image data is started.

A notification unit 816 displays various types of notification information on the console 806. The notification unit 816 may send the various types of notification information to an external device via the communication circuit 805.

The image processing unit 803 executes image processing on a user image (e.g., a document or a photo) prepared as desired by a user based on a print job supplied from an external device, generates image data, and outputs the image data (an image signal) to the exposure apparatus 2. The image processing includes color conversion, gamma correction, binarization processing, and the like, for example. An addition unit 804 adds the adhesive image Aim to the user image. If the user image already includes the adhesive image Aim, the addition unit 804 does not add the adhesive image Aim to the user image.

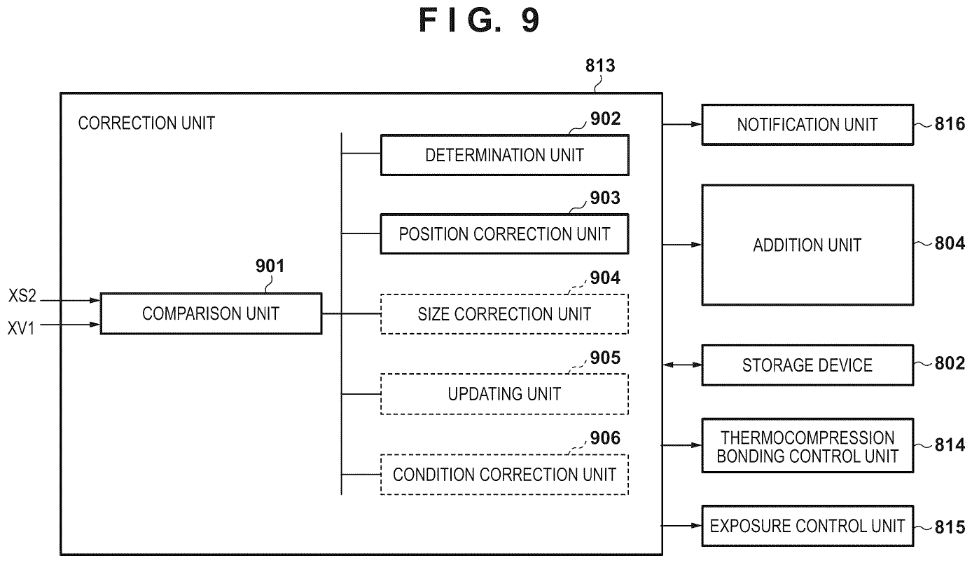

FIG. 9 illustrates the correction unit 813 in detail. A comparison unit 901 compares the image distance XS2 and the pressing distance XV1, obtained by the obtainment unit 811, and outputs a comparison result. For example, the comparison unit 901 may calculate the misalignment amount dX, which is the difference between the image distance XS2 and the pressing distance XV1, and output the misalignment amount dX.

A determination unit 902 may determine, for example, whether the misalignment amount dX is within a permissible range. Correction processing is required if the misalignment amount dX is outside the permissible range. The correction processing is unnecessary if the misalignment amount dX is within the permissible range. The permissible range may also be called a “reference range”. If the misalignment amount dX is not within the permissible range, the notification unit 816 may output a message to that effect.

A position correction unit 903 corrects the position at which the adhesive image Aim is formed based on the misalignment amount dX. Note that the determination unit 902 may determine whether a correction value for the position where the adhesive image Aim is formed is within a correctable range. If the correction value is outside the correctable range, the notification unit 816 may output a message to that effect.

A size correction unit 904 corrects the size of the adhesive image Aim (in particular, the width W in the X direction) based on, for example, the misalignment amount dX. The size of the adhesive image Aim may be reduced if the misalignment amount dX is sufficiently small. The size of the adhesive image Aim may be increased if the misalignment amount dX is too large.

An updating unit 905 obtains a distance XPr from the end of the sheet S to the center line of the actual pressing region based on a detection result for the test image obtained through the obtainment unit 811 or the measurement unit 812. The updating unit 905 further overwrites the pressing distance XV1 stored in the storage device 802 with the distance XPr. The pressing distance XV1 may be used as a reference position at which the adhesive image Aim is formed on the sheet S (the distance XS1).

A condition correction unit 906 corrects the booklet creation conditions of the adhesive image Aim (e.g., an image formation condition and a thermocompression bonding condition) based on the misalignment amount dX, the optical density of the adhesive image Aim, or the like. The image formation condition may be the exposure light amount for forming the adhesive image Aim. The thermocompression bonding condition may be the thermocompression bonding time, the heating temperature, or the pressure for the adhesive image Aim.

### 1-10. Flowchart

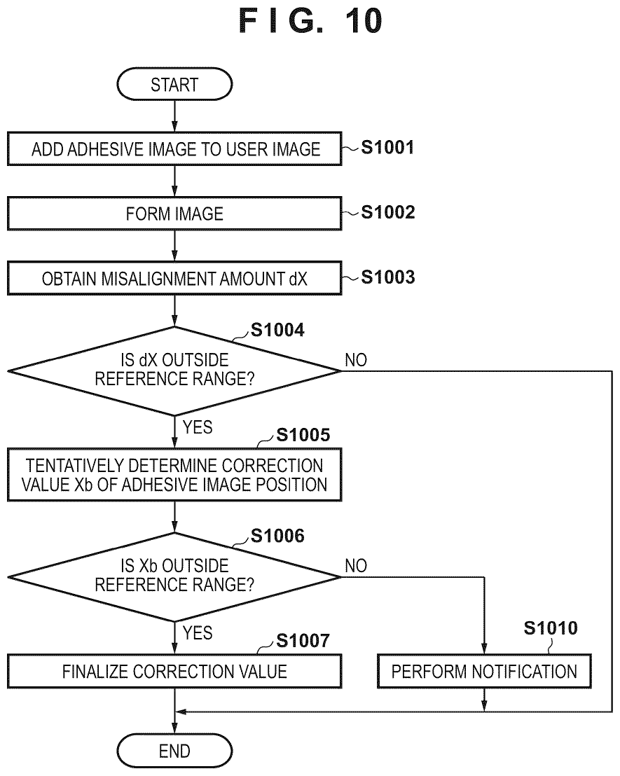

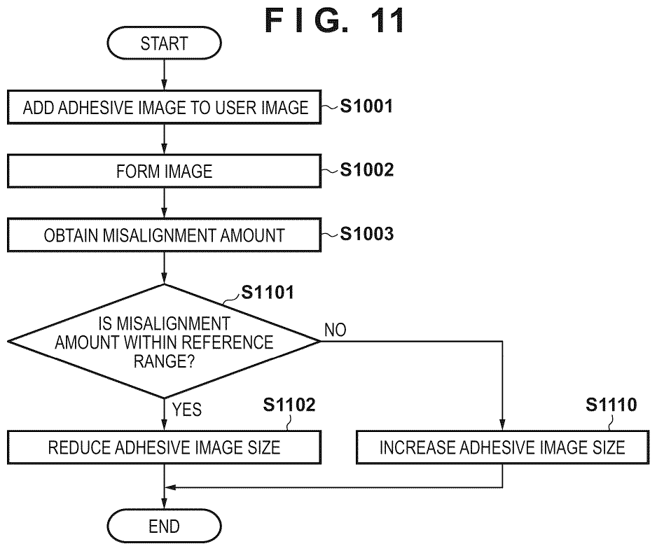

FIG. 10 is a flowchart illustrating processing for correcting the position of the adhesive image. The CPU 801 executes the following processing upon receiving a print job from an external device.

In step S1001, the CPU 801 causes the image processing unit 803 to generate image data (a user image) based on the print job, and adds the adhesive image Aim (the adhesive image Aim1) to the user image.

In step S1002, the CPU 801 forms an image on the sheet S by controlling the image forming apparatus 100. For example, the CPU 801 forms the user image and the adhesive image Aim on the sheet S by outputting, to the exposure apparatus 2, image data formed by the image processing unit 803 adding the adhesive image Aim to the user image.

In step S1003, the CPU 801 (the obtainment unit 811) obtains the misalignment amount dX of the adhesive image Aim formed on the sheet S. For example, the CPU 801 causes the reading unit 125 to read the adhesive image Aim of the sheet S, obtains a reading result (the adhesive image Aim2) from the reading unit 125, and stores the reading result in the storage device 802. The CPU 801 (the comparison unit 901) calculates the misalignment amount dX based on the image distance XS2 for the adhesive image Aim2 and the pressing distance XV1 for the pressing region V1 of the thermocompression bonding unit 51.

In step S1004, the CPU 801 (the determination unit 902) determines whether the misalignment amount dX is outside the reference range. For example, when the misalignment amount dX exceeds 1 mm, the CPU 801 determines that the misalignment amount dX is outside the reference range. When the misalignment amount dX is no greater than 1 mm, the misalignment amount dX is determined to be within the reference range, and the CPU 801 ends the correction processing. When the misalignment amount dX exceeds 1 mm, the CPU 801 moves the sequence from step S1004 to step S1005.

In step S1005, the CPU 801 (the position correction unit 903) tentatively determines a correction value Xb based on the misalignment amount dX. The correction value Xb is calculated through the following equation, for example.

Xb=XS2−XV1 Eq 3

In step S1006, the CPU 801 (the determination unit 902) determines whether the correction value Xb is within the reference range. The reference range may also be called the “correctable range”. It is necessary for the adhesive image Aim to be formed in the margin region of the sheet S. Accordingly, when the corrected adhesive image Aim protrudes from the margin region, the correction value Xb is determined to be outside the reference range. When the corrected adhesive image Aim does not protrude from the margin region, the correction value Xb is determined to be within the reference range. When the correction value Xb is outside the reference range, the CPU 801 moves the sequence to step S1010. In step S1010, the CPU 801 makes a notification to notify the user that correction is not possible. This notification can include a notification that poor bonding may occur, or can include prompting the user to correct the positions of the sheets S held in the sheet cassette 8. In this case, the correction value Xb is discarded. If the correction value Xb is within the reference range, the CPU 801 moves the sequence from step S1006 to step S1007.

In step S1007, the CPU 801 (the position correction unit 903) finalizes the correction value Xb. In other words, the CPU 801 corrects the position at which the adhesive image Aim is formed according to the correction value Xb. When the correction value Xb exceeds 0, the position of the adhesive image Aim on the next page is shifted in the +X direction by an amount equivalent to the correction value Xb. In other words, the position of the adhesive image Aim1 is corrected in the image data serving as the basis of the adhesive image Aim.

When the correction value Xb is less than 0, the position of the adhesive image Aim on the next page is shifted in the −X direction by an amount equivalent to the correction value Xb. In other words, the position of the adhesive image Aim1 is corrected in the image data serving as the basis of the adhesive image Aim.

The reference range of the correction value Xb is at least −2 mm and at most +2 mm. Thereafter, a user image accompanied by the adhesive image Aim for which the formation position has been corrected is formed on the sheet S. When a predetermined number of sheets S are stacked on the intermediate stacking unit 42, the thermocompression bonding unit 51 performs the thermocompression bonding processing. A booklet is completed as a result.

### 1-11. Verification Results

1,000 booklets having 10 sheets S each were created using the image forming system 1 according to the first embodiment. As a result, none of the 1,000 booklets showed adhesion defects. As a comparative example, 1,000 booklets having 10 sheets S each were created using the image forming system 1 without correcting the formation position of the adhesive image Aim. In this case, three of the booklets showed adhesion defects.

According to the first embodiment, the method for creating a booklet is improved. In particular, the position of the adhesive image Aim formed on the first sheet S is obtained, and the position of the adhesive image Aim formed on the second and subsequent sheets S is corrected in accordance with the obtained position. This makes it unnecessary for the user to specify the adhesion strength, which lightens the burden on the user. This also makes it possible to obtain a booklet having sufficient adhesion strength.

In the first embodiment, the position of the adhesive image Aim1 in the image data used to form the adhesive image Aim is corrected uniformly using the correction value Xb. However, this is merely one example. The sheet S may be divided into N regions in the Y direction. The misalignment amount dXi may then be obtained for each of the N regions. A misalignment amount dXi is the amount of misalignment of the adhesive image Aim in the i-th region. A correction value Xbi of the i-th region is determined based on the misalignment amount dXi of the i-th region. This correction method may be particularly effective when the adhesive image Aim2 is slanted relative to the pressing region V1.

Although the image forming system 1 illustrated in FIG. 1 includes the image forming apparatus 100 capable of forming color images, this is merely one example. The image forming apparatus 100 may be an image forming apparatus capable of forming monochromatic images. The numerical values described in the first and following embodiments are also merely examples.

### 2. Second Embodiment

In a second embodiment, the size of the adhesive image Aim (the adhesive image Aim1) is changed. This reduces the amount of toner consumed in creating the booklet. The basic configuration and operations of the image forming system 1 of the second embodiment are as described in the first embodiment. Hereinafter, points unique to the second embodiment will be described in detail, and the descriptions of the first embodiment will be applied for other matters.

### 2-1. Flowchart

FIG. 11 is a flowchart illustrating correction processing according to the second embodiment. In FIG. 11, steps S1004 to S1010 in FIG. 10 have been replaced with steps S1101, S1102, and S1110.

In step S1101, the CPU 801 (the determination unit 902) determines whether the misalignment amount dX is inside the reference range. The reference range is no more than 0.75 mm, for example. In other words, if the misalignment amount dX is no more than 0.75 mm, the misalignment amount dX is determined to be within the reference range. When the misalignment amount dX is within the reference range, the misalignment amount between the adhesive image Aim (the adhesive image Aim2) formed on the sheet S and the pressing region V1 of the thermocompression bonding unit 51 is sufficiently small. When the misalignment amount dX is no more than 0.75 mm, the CPU 801 moves the sequence from step S1101 to step S1102.

In step S1102, the CPU 801 (the size correction unit 904) reduces the size of the adhesive image Aim formed on the sheet S. For example, the CPU 801 changes the width of the adhesive image Aim1 in the image data from W to W′ (where W>W′). For example, W is 4 mm and W′ is 3 mm. When the misalignment amount dX is sufficiently small, the pressing region V1 does not protrude from the adhesive image Aim formed on the sheet S. This ensures sufficient adhesion strength. For example, the size of the adhesive image Aim formed on the second and subsequent sheets S is reduced based on the misalignment amount dX of the adhesive image Aim formed on the first sheet S. This reduces the amount of toner consumed.

The misalignment amount dX between the adhesive image Aim2 and the pressing region V1 of the thermocompression bonding unit 51 may be outside the reference range. For example, when the misalignment amount dX exceeds 0.75 mm, the CPU 801 moves the sequence from step S1101 to step S1110.

In step S1110, the CPU 801 (the size correction unit 904) increases the size of the adhesive image Aim. For example, if the width of the current adhesive image Aim1 is W′, the width of the adhesive image Aim1 is changed to W. Note that if the width of the current adhesive image Aim1 is already W, the width of the adhesive image Aim1 is kept at W.

### 2-2. Verification Results

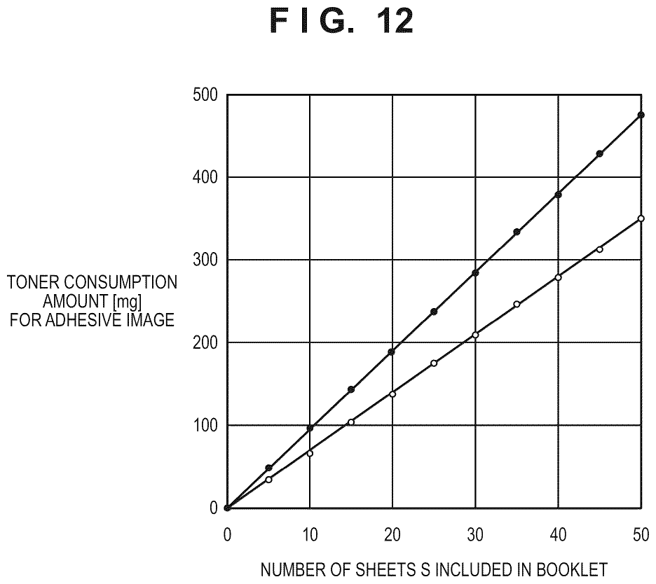

FIG. 12 illustrates verification results. The horizontal axis represents the number of sheets S included in the booklet. The vertical axis represents the toner consumption amount for the adhesive image Aim. The toner consumption amount increases with the number of sheets S. The black dots represent the toner consumption amount in a comparative example. The white dots represent the toner consumption amount in the second embodiment. The size correction of the second embodiment is not performed in the comparative example. As illustrated in FIG. 12, it can be seen that by applying the second embodiment, the amount of toner required to be consumed to form the adhesive image Aim on the sheet S is lower than in the comparative example.

According to the second embodiment, the size of the adhesive image Aim is reduced in accordance with the misalignment amount dX of the position of the adhesive image Aim formed on the sheet S. This reduces the toner consumption amount, which improves the method for creating the booklet.

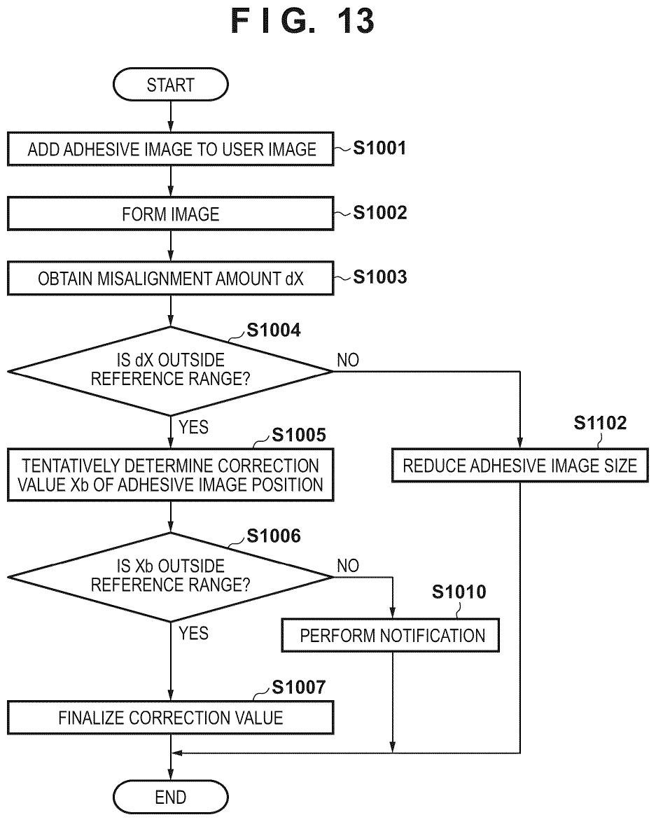

Although only the size of the adhesive image Aim is corrected in the second embodiment, this is merely one example. The correction of the position of the adhesive image Aim described in the first embodiment may also be combined with the second embodiment. Specifically, as illustrated in FIG. 13, the CPU 801 executes step S1102 when the misalignment amount dX is determined to be within the reference range in step S1004. Changing both the size and the formation position of the adhesive image Aim in this manner makes it possible both to ensure sufficient adhesion strength and to save toner.

### 3. Third Embodiment

In a third embodiment, the pressing distance XV1 indicating the pressing position of the thermocompression bonding unit 51 used to determine the misalignment amount dX is corrected or updated by reading the actual pressing position of the thermocompression bonding unit 51 using the reading unit 126. This makes it possible to obtain the amount of misalignment of the adhesive image Aim with greater accuracy. The basic configuration and operations of the image forming system 1 of the third embodiment are as described in the first embodiment. Hereinafter, points unique to the third embodiment will be described in detail, and the descriptions of the first embodiment will be applied for other matters.

### 3-1. Image Forming System

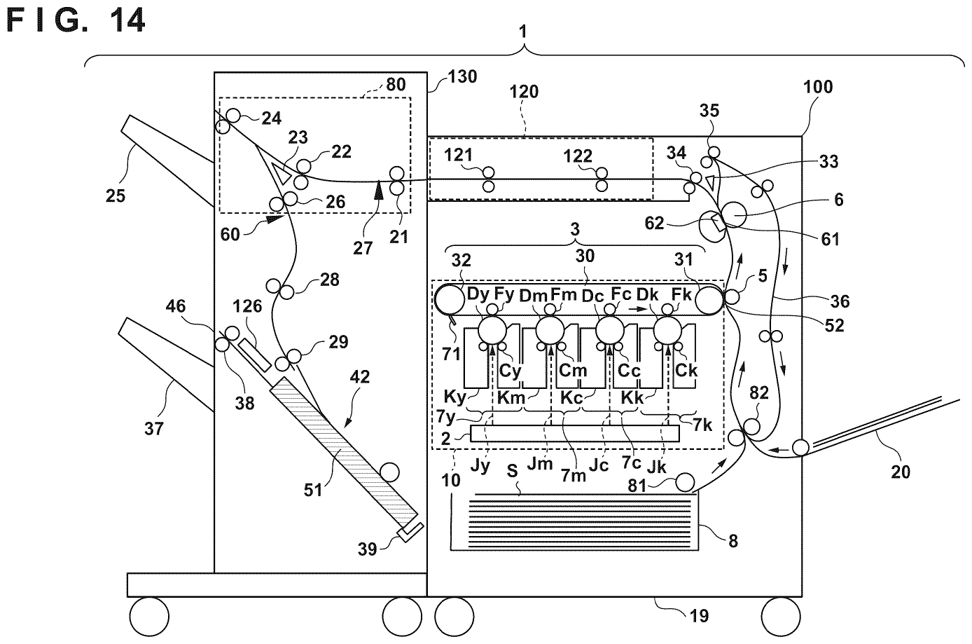

FIG. 14 illustrates the image forming system 1 of the third embodiment. Although the reading unit 125 is disposed in the image forming apparatus 100 in FIG. 1, in the third embodiment, the reading unit 126 is disposed in the post-processing apparatus 130. The reading unit 125 may be disposed in the image forming apparatus 100 in the third embodiment as well.

The reading unit 126 is disposed between the intermediate stacking unit 42 and the discharge roller pair 38. As described above, when the thermocompression bonding unit 51 completes the thermocompression bonding processing on a booklet, the booklet is pushed toward the discharge port 46. Here, the reading unit 126 reads the surface of the booklet that is discharged from the intermediate stacking unit 42 toward the discharge port 46. The reading unit 126 sends the reading result to the CPU 801. A single sheet S may be read instead of the booklet.

### 3-2. Flowchart

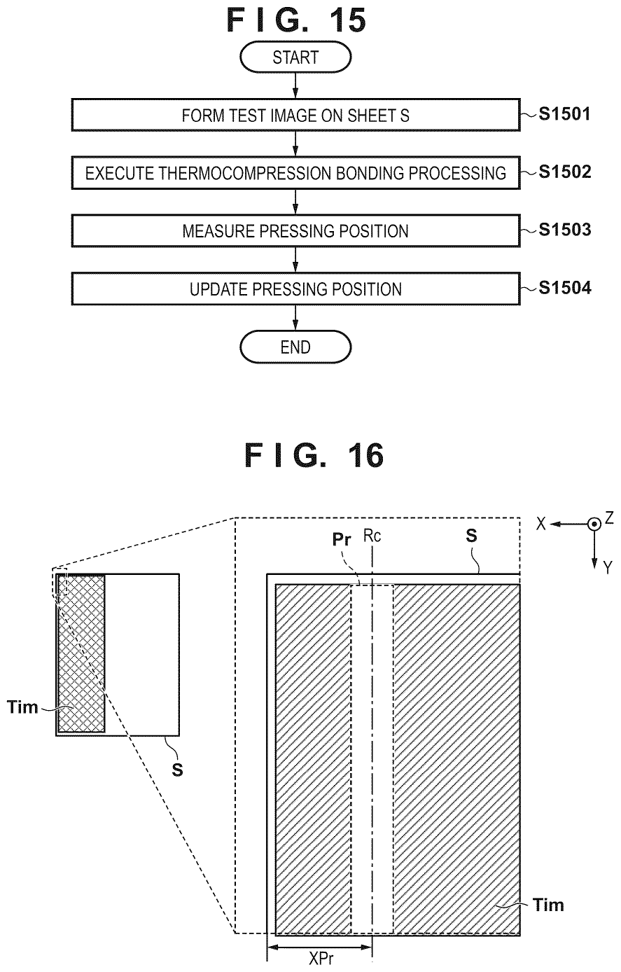

FIG. 15 illustrates a method for updating information on the pressing position of the thermocompression bonding unit 51 stored in the storage device 802 (the pressing distance XV1). The following method is performed before the booklet is created. An instruction to update the pressing position being entered using the console 806 may be used as a trigger, for example. Alternatively, a large change in ambient temperature or ambient humidity detected by an environment sensor may be used as the trigger. The total number of images formed exceeding a threshold may also be used as the trigger.

In step S1501, the CPU 801 (the measurement unit 812) forms a test image on the sheet S. The test image is formed on a surface that can be read by the reading unit 126.

FIG. 16 illustrates a sheet S (a test sheet) on which a test image Tim is formed. The region where the test image Tim is formed on the sheet S is a region that the pressing part 409 is likely to contact.

In step S1502, the CPU 801 (the thermocompression bonding control unit 814) performs thermocompression bonding processing by the thermocompression bonding unit 51 on the sheet S on which the test image Tim is formed. As illustrated in FIG. 16, in the test image Tim, the density in a region Pr subjected to the thermocompression bonding processing by the pressing part 409 is lower than the density of the surrounding region. This is caused by remelted toner permeating the sheet S or toner adhering to the pressing part 409. Accordingly, the region Pr where the density has decreased in the test image Tim is the actual pressing region.

In step S1503, the CPU 801 (the measurement unit 812) causes the reading unit 126 to read the test image Tim on the sheet S, and measures the pressing position based on the reading result. The measurement unit 812 analyzes the read image to identify the region Pr having a density lower than the density of the surrounding region as the pressing region (a read pressing position). Furthermore, the measurement unit 812 calculates a center line Cr of the region Pr, and calculates a distance from the end of the sheet S to the center line Cr (the actual pressing distance XPr).

In step S1504, the CPU 801 updates the pressing position stored in the storage device 802 (the pressing distance XV1) using the actual pressing distance XPr. For example, the pressing distance XV1 stored in the storage device 802 is overwritten by the actual pressing distance XPr. When the pressing distance XV1 is updated, the position of the adhesive image Aim1 in the image data is also updated. In other words, the position of the adhesive image Aim formed on the sheet S is corrected. The updated pressing distance XV1 is then used when the user image and the adhesive image Aim are formed on the sheet S. The pressing distance XV1 input to the comparison unit 901 described in the first embodiment and the second embodiment is also updated.

Identifying the actual pressing position of the pressing part 409 in this manner improves accuracy with which the misalignment amount dX is obtained, and improves the accuracies of the position correction and size correction as well. This is because the misalignment amount dX is calculated based on the pressing distance XV1.

The CPU 801 (the notification unit 816) may notify the user of the result of measuring the actual pressing position or information indicating the state of the image forming system 1. This enables the user to perform any necessary maintenance on the image forming system 1.

Although the third embodiment describes the position or size of the adhesive image Aim being changed in accordance with the actual pressing position, this is merely one example. The CPU 801 may control the motor M3 in accordance with the actual pressing position to mechanically adjust the pressing position of the thermocompression bonding unit 51. The motor M3 can move the lateral reference plates 72a and 72b in the +X direction or the −X direction. As a result, the pressing position of the pressing part 409 with respect to the sheet S may be corrected. In this case, the misalignment amount dX is reduced without correcting the position at which the adhesive image Aim is formed on the sheet S.

### 4. Fourth Embodiment

In a fourth embodiment, an attempt is made to ensure sufficient adhesion strength by correcting image formation conditions (e.g., the exposure light amount) of the adhesive image Aim in accordance with the optical density of the adhesive image Aim.

### 4-1. Image Forming System 1

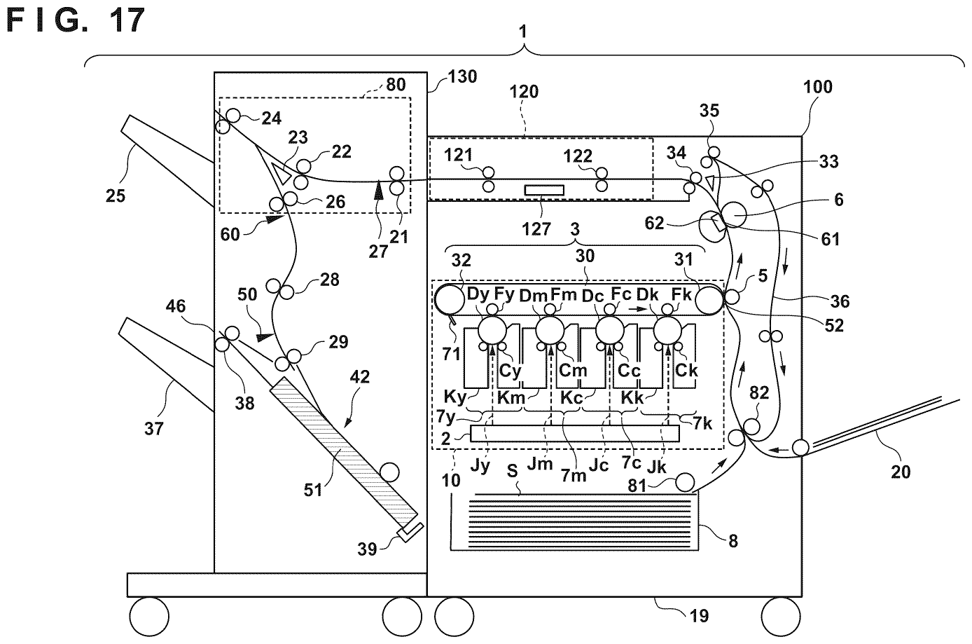

FIG. 17 illustrates the image forming system 1 of the fourth embodiment. As illustrated in FIG. 17, a density sensor 127 is provided instead of the reading unit 125 or in addition to the reading unit 125. The fourth embodiment can be combined with any of the embodiments described above.

In the fourth embodiment, the density sensor 127 detects the density of the adhesive image Aim formed on a preceding sheet S or a test sheet. The CPU 801 (the obtainment unit 811) corrects the exposure light amount of the adhesive image Aim formed on subsequent sheets S in accordance with the density detection result. In other words, the exposure light amount is corrected such that the adhesive image Aim is formed having a density at which sufficient adhesion strength is achieved. This lightens the burden on the user and ensures sufficient adhesion strength.

The density of the adhesive image Aim may fluctuate due to variations among individual image forming apparatuses 100, process cartridges 7, and the like. If the density of the adhesive image Aim is less than the expected density, sufficient adhesion strength cannot be achieved. It is therefore effective to correct the density of the adhesive image Aim.

A density sensor 127 that is smaller and simpler than the reading unit 125 may be used. As a result, the image forming system 1 of the fourth embodiment is made smaller or simpler than that of the first embodiment.

### 4-2. Relationship Between Adhesive Image Density and Adhesion Strength

FIG. 7B illustrates results of an experiment regarding the relationship between the density of the adhesive image Aim and the adhesion strength. Test specimens F1 to F3 were created using four different process cartridges A to D for each, and the adhesion strengths thereof were measured. An adhesion strength of at least 1.0 N/cm was ensured when the optical density of the adhesive image Aim was at least 1.4. The results were therefore determined to be good.

The adhesion strength was lower than 1.0 N/cm when the optical density of the adhesive image Aim was lower than 1.4. An adhesion strength lower than 1.0 N/cm may be insufficient. The strength was therefore determined to be insufficient.

### 4-3. Flowchart

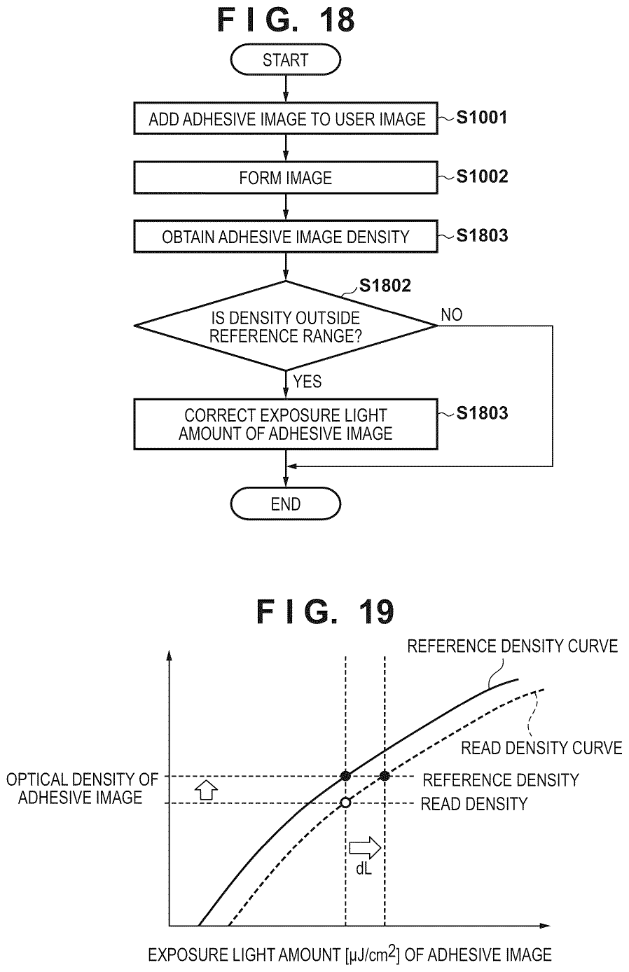

FIG. 18 is a flowchart illustrating density correction performed on the adhesive image Aim. Compared to FIG. 10, in FIG. 18, the processing from step S1003 onward is replaced with steps S1801 to S1803.

In step S1801, the CPU 801 (the obtainment unit 811) controls the density sensor 127 to detect an optical density of the adhesive image Aim formed on the sheet S.

In step S1802, the CPU 801 (the determination unit 902) determines whether the optical density of the adhesive image Aim is outside the reference range. The determination unit 902 determines, for example, whether the optical density of the adhesive image Aim is below a threshold (e.g., 1.4). When the optical density is within the reference range, the CPU 801 does not correct the density (the exposure light amount). On the other hand, when the optical density is outside the reference range, the CPU 801 moves the sequence from step S1802 to step S1803.

In step S1803, the CPU 801 corrects the exposure light amount used when forming the adhesive image Aim based on the detected optical density. The exposure light amount is increased, for example.

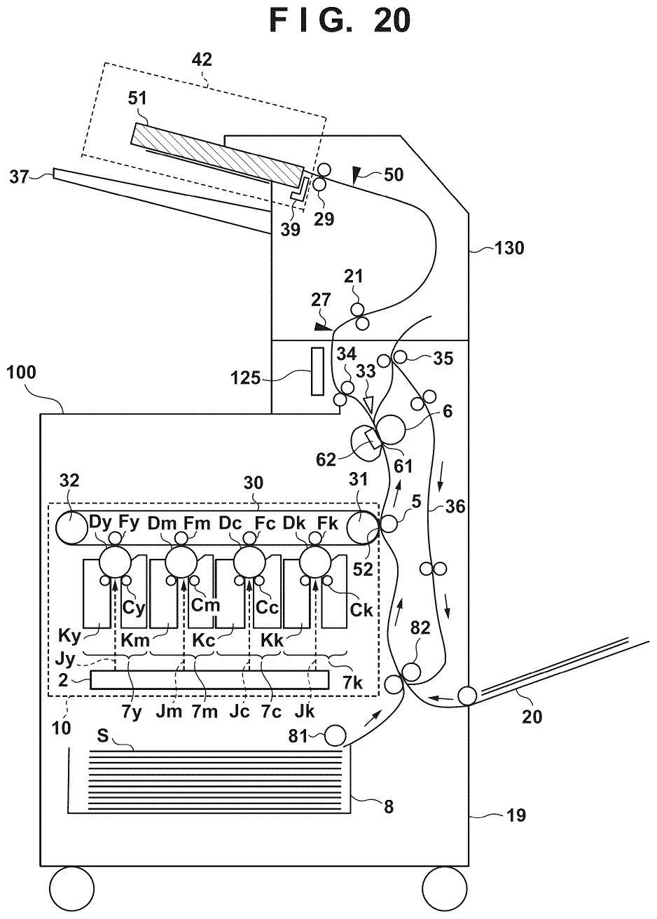

FIG. 19 is a graph illustrating a relationship between the exposure light amount and the optical density of the adhesive image Aim. There are cases where a read density curve of the image forming apparatus 100 is shifted from a reference density curve. The CPU 801 determines a correction value dL for the exposure light amount that shifts the density of the adhesive image Aim from the read density back to the reference density, and increases the exposure light amount of the adhesive image Aim using the correction value dL. The CPU 801 then forms the adhesive image Aim on the subsequent sheet S using the corrected exposure light amount.

### 4-4. Verification Results

The inventors created 1,000 booklets using 20 different process cartridges 7. 50 booklets were created using a single process cartridge 7. Each booklet was formed from 10 sheets S. The fourth embodiment was applied, and each of the 1,000 booklets therefore had a good adhesive state. The density correction of the fourth embodiment was not used in the comparative example. 1,000 booklets were also created in the comparative example. In the comparative example, adhesion defects occurred in three of the booklets.

According to the fourth embodiment, the result of detecting the density of the adhesive image Aim formed on the preceding sheet S is fed back into the formation of the adhesive image Aim on the subsequent sheet S. This both reduces the effort required of the user and ensures sufficient adhesion strength.

The fourth embodiment focused on density fluctuations caused by individual variations in the image forming apparatuses 100 or the process cartridges 7. However, this is merely one example. The CPU 801 may use an environment sensor to detect environmental conditions (e.g., the ambient temperature or the ambient humidity) and correct the exposure light amount in accordance with the environmental conditions. The CPU 801 may count the total number of images formed and correct the exposure light amount of the adhesive image Aim in accordance with the number of images formed.

The notification unit 816 may display a message on the console 806 in accordance with the result of detecting the optical density of the adhesive image Aim. The user may then instruct the image forming system 1 to execute the correction processing described in the fourth embodiment in response to the message.

Although the fourth embodiment describes the image formation conditions as being corrected when the optical density of the adhesive image Aim changes, this is merely one example. For example, the CPU 801 may correct the thermocompression bonding conditions (the thermocompression bonding time) based on the detection result of the optical density. The CPU 801 increases the thermocompression bonding time when the optical density drops below a threshold. A correction value added to an initial value of the thermocompression bonding time is 2 seconds, for example. The correction value for the thermocompression bonding time may be determined according to the difference between the detected optical density and the threshold. Increasing the thermocompression bonding time increases the adhesion between the sheet S and the toner (the adhesive image Aim). Accordingly, sufficient adhesion strength is ensured even if the toner amount of the adhesive image Aim decreases. The CPU 801 may increase the exposure light amount in accordance with the misalignment amount dX. In this case, sufficient adhesion strength may be ensured by increasing the exposure light amount as the misalignment amount dX increases.

### 5. Other

Although FIG. 1 illustrates the post-processing apparatus 130 having the thermocompression bonding unit 51 as being disposed next to the image forming apparatus 100, this is merely an example. As illustrated in FIG. 20, the post-processing apparatus 130 and the thermocompression bonding unit 51 may be disposed in an upper part of the main body of the image forming apparatus 100. In this case, the discharge rollers 34 directly pass the sheet S to the post-processing apparatus 130. When the sheet sensor 27 detects the leading end of the sheet S, the inlet rollers 21 convey the sheet S. Furthermore, the kick-out roller pair 29 conveys the sheet S to the intermediate stacking unit 42. Note that the conveyance direction of the sheet S to the intermediate stacking unit 42 in FIG. 20 is opposite from the conveyance direction of the sheet S to the intermediate stacking unit 42 in FIG. 1.

As illustrated in FIG. 20, the reading unit 125 is disposed in a conveyance path connecting the discharge rollers 34 and the inlet rollers 21. The density sensor 127 may be provided instead of the reading unit 125 or in addition to the reading unit 125.

### 6. Technical Spirit Derived from Embodiments

The image forming apparatus 100 and the image forming unit 10 function as an image forming unit configured to form an adhesive image on a sheet based on first adhesive image information. The reading units 125 and 126 and the density sensor 127 function as a detecting unit configured to output second adhesive image information by detecting the adhesive image formed on the sheet. The post-processing apparatus 130 and the thermocompression bonding unit 51 function as a booklet creating unit configured to create a booklet by pressing and heating the sheet at a predetermined pressing position to melt the adhesive image and form an adhesive layer, and adhere a plurality of the sheets together by the adhesive layer. The CPU 801 and the correction unit 813 are configured to, in accordance with a difference between the predetermined pressing position and a position of the adhesive image in the second adhesive image information (e.g., the misalignment amount dX), correct one of the first adhesive image information, the predetermined pressing position, an image formation condition of the image forming unit, and a booklet creation condition of the booklet creating unit that affects an adhesion strength of the adhesive image. Through this, a method for creating booklets may be improved.

The correction unit 813 may be configured to correct a position of the adhesive image in the first adhesive image information in accordance with the difference. Sufficient adhesion strength may be ensured by correcting the image data of the adhesive image Aim or correcting the writing position of the adhesive image Aim in this manner.

The correction unit 813 may be configured to correct a size of the adhesive image in the first adhesive image information in accordance with the difference. Through this, sufficient adhesion strength may be ensured, and toner consumption may be reduced.

The motor M3 may function as a movement unit configured to mechanically move the pressing part 409 to the pressing position. The correction unit 813 may correct the pressing position with respect to the adhesive image Aim formed on the sheet S by controlling the motor M3 in accordance with the misalignment amount dX.

The correction unit 813 may reduce a size of the adhesive image in the first adhesive image information when the misalignment amount dX is within a permissible range. Through this, the toner consumption amount may be reduced.

The correction unit may be configured to calculate the difference using the actual pressing position measured by the measuring unit.

The reading unit 126 and the measurement unit 812 function as a measuring unit configured to measure, based on a detection result of the detecting unit detecting a test sheet on which a test image has been formed, a predetermined pressing position on the test sheet. The correction unit 813 may calculate the difference (e.g., the misalignment amount dX) using the predetermined pressing position measured.

As illustrated in FIG. 16, the test image Tim may include a solid image having a predetermined density. The measurement unit 812 may identify, as the predetermined pressing position, a position where a density is lower than a surrounding density in the solid image included in the detection result (e.g., the region Pr).

The storage device 802 functions as a storage unit configured to store the predetermined pressing position. The correction unit 813 may update the predetermined pressing position stored in the storage unit with the actual pressing position measured. Through this, the predetermined pressing position may be corrected. This improves the accuracy with which the difference (the misalignment amount dX) is measured, as well as the accuracy with which the adhesive image Aim is corrected.

The determination unit 902 may determine whether the position of the adhesive image in the second adhesive image information is within a correctable range. The notification unit 816 may make a notification when the position of the adhesive image in the second adhesive image information is not in the correctable range. Through this, the user can know whether the position of the adhesive image can be corrected.

The reading unit 125 is an example of a reading unit configured to read the adhesive image formed on the sheet and output the second adhesive image information, the second adhesive image information being a reading result of reading the adhesive image.

The density sensor 127 is an example of a detection unit configured to detect the density of the adhesive image Aim formed on a sheet. The correction unit 813 may correct the exposure light amount in accordance with the density of the adhesive image Aim. Through this, sufficient adhesion strength may be ensured.

The reading unit 126 and the measurement unit 812 are an example of an identifying unit that identifies, based on a reading result from the reading unit, an actual pressing position that is a position pressed by the booklet creating unit in the test sheet. This saves the user the trouble of measuring the actual pressing position using a ruler. Through this, a method for creating booklets may be indirectly improved.

The correction unit 813 may correct the formation position of the adhesive image Aim or the size of the adhesive image Aim such that the adhesive image Aim is formed at the actual pressing position identified by the measurement unit 812.

The correction unit 813 may reduce the size of the adhesive image Aim in accordance with the pressing position identified by the measurement unit 812. Through this, sufficient adhesion strength may be ensured, and toner may be conserved as well.

The pressing position used to correct the adhesive image Aim, stored in the storage device 802, may be corrected to the actual pressing position. Through this, the accuracy with which the adhesive image Aim is corrected is also improved.

The obtainment unit 811 and the density sensor 127 function as an obtaining unit configured to obtain an optical density of an image formed on a sheet output from an image forming unit. The correction unit 813 may correct at least one of the image formation condition or the booklet creation condition used to form the adhesive image Aim in accordance with the result of detecting the optical density.

Sufficient adhesion strength may be ensured by correcting the thermocompression bonding time.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016284, filed Feb. 3, 2025, which is hereby incorporated by reference herein in its entirety.

What is claimed is:

1. A booklet creating apparatus comprising:
an image forming unit configured to form, on a sheet, an adhesive image based on first adhesive image information, the first adhesive image information including data indicative of a target position on the sheet at which the adhesive image is to be formed;
a detecting unit configured to detect the adhesive image formed on the sheet and to output second adhesive image information including position information indicative of an actual position of the adhesive image on the sheet;
a booklet creating unit configured to create a booklet by pressing and heating the sheet at a predetermined pressing position to melt the adhesive image and form an adhesive layer, and adhering a plurality of sheets together via the adhesive layer; and
a processor configured to, in accordance with a difference between (i) the predetermined pressing position and (ii) the actual position of the adhesive image indicated by the position information included in the second adhesive image information, correct at least one of the first adhesive image information, the predetermined pressing position, an image formation condition of the image forming unit, and a booklet creation condition of the booklet creating unit.

2. The booklet creating apparatus according to claim 1,
wherein the processor is further configured to correct a position of the adhesive image in the first adhesive image information in accordance with the difference.

3. The booklet creating apparatus according to claim 1,
wherein the processor is further configured to correct a size of the adhesive image in the first adhesive image information in accordance with the difference.

4. The booklet creating apparatus according to claim 1, further comprising:
a movement unit configured to mechanically move a pressing position of the booklet creating unit,
wherein the processor is further configured to correct the pressing position with respect to the adhesive image formed on the sheet, by controlling the movement unit in accordance with the difference.

5. The booklet creating apparatus according to claim 1,
wherein the processor is further configured to reduce a size of the adhesive image in the first adhesive image information if the difference is within a permissible range.

6. The booklet creating apparatus according to claim 1, further comprising:
a measuring unit configured to measure an actual pressing position on a test sheet on which a test image is formed, based on a detection result of the detecting unit performing detection on the test sheet,
wherein the processor is further configured to calculate the difference using the actual pressing position measured by the measuring unit.

7. The booklet creating apparatus according to claim 6,
wherein the test image is a solid image having a predetermined density, and
the measuring unit identifies, as the actual pressing position, a position where a density is lower than a surrounding density in the solid image included in the detection result.

8. The booklet creating apparatus according to claim 6, further comprising:
a storage unit configured to store the predetermined pressing position,
wherein the processor is further configured to correct the predetermined pressing position by updating the predetermined pressing position stored in the storage unit with the actual pressing position measured by the measuring unit.

9. The booklet creating apparatus according to claim 1,
wherein the processor is further configured to:
determine whether the position of the adhesive image in the second adhesive image information is within a correctable range; and
make a notification indicating that the position of the adhesive image in the second adhesive image information is not in the correctable range.

10. The booklet creating apparatus according to claim 1,
wherein the detecting unit includes a reading unit configured to read the adhesive image formed on the sheet and output the second adhesive image information, the second adhesive image information being a reading result of reading the adhesive image.

11. The booklet creating apparatus according to claim 1,
wherein the detecting unit includes a sensor configured to detect a density of the adhesive image formed on the sheet, and
the processor is further configured to correct an exposure light amount included in the image formation condition in accordance with the density of the adhesive image.

12. A booklet creating apparatus comprising:
an image forming unit configured to form an image on a sheet using toner, based on input image data;
a booklet creating unit configured to create a booklet by pressing and heating a plurality of sheets output from the image forming unit to melt an adhesive image among formed images and form an adhesive layer, and adhere the plurality of sheets together via the adhesive layer;
a reading unit configured to read a test sheet on which a test image was formed by the image forming unit and that was heated and pressed by the booklet creating unit; and
a processor configured to identify, based on a reading result from the reading unit, an actual pressing position that is a position pressed by the booklet creating unit on the test sheet.

13. The booklet creating apparatus according to claim 12,
wherein the test image is a solid image having a predetermined density, and
the processor is further configured to identify, as the actual pressing position, a position where a density is lower than a surrounding density in the solid image included in the reading result.

14. The booklet creating apparatus according to claim 12,
wherein the processor is further configured to correct a formation position of the adhesive image or a size of the adhesive image such that the adhesive image is formed at the identified actual pressing position.

15. The booklet creating apparatus according to claim 14,
wherein the processor is further configured to reduce the size of the adhesive image in accordance with the identified actual pressing position.

16. The booklet creating apparatus according to claim 12, further comprising:
a storage unit configured to store a reference position that is a position at which the adhesive image is formed on the sheet,
wherein the processor is further configured to correct the reference position in accordance with the identified actual pressing position.

17. A booklet creating apparatus comprising:
an image forming unit configured to form an image on a sheet using toner, based on input image data;
a booklet creating unit configured to create a booklet by pressing and heating a plurality of sheets output from the image forming unit to melt an adhesive image among formed images and form an adhesive layer, and adhere the plurality of sheets together via the adhesive layer; and
a processor configured to:
obtain an optical density of an image formed on a sheet output from the image forming unit; and
correct at least one of an image formation condition used by the image forming unit to form the adhesive image and a booklet creation condition of the booklet creating unit, in accordance with the optical density.

18. The booklet creating apparatus according to claim 17,
wherein the image formation condition includes an exposure light amount used by an exposure unit provided in the image forming unit to expose a photosensitive member.

19. The booklet creating apparatus according to claim 1,
wherein the booklet creation condition includes a pressing time that is a time for which the plurality of sheets are pressed by the booklet creating unit.
